(19) United States
(12) Patent Application Publication
(10) Pub. No.: US 2009/0046855 A1
(43) Pub. Date: Feb. 19, 2009

(54) Method and apparatus for caching access information for faster digital cable tuning

(76) Inventors: Kevin Lloyd Grimes, Maple Grove, MN (US); James Duane Tenbarge, Fishers, IN (US); Robert Vincent Krakora, Carmel, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/920,182

(22) PCT Filed: May 5, 2006
(86) PCT No.: PCT/US2006/017266

§ 371 Date: Nov. 9, 2007

Related U.S. Application Data
(60) Provisional application No. 60/679,324, filed on May 10, 2005.

(51) Int. Cl. H04N 7/167

(52) U.S. Cl. 380/200

(57) ABSTRACT

A method and apparatus is presented for providing faster tuning of a digital television channel. Specifically, the present invention is directed to a digital television receiver including a tuner, at least one demodulator, a detachable security module such as a point of deployment (POD) module, a transport demultiplexer, and a microprocessor having a cache or memory device for storing “conditional access program map table” (CA_PMT) information. The cache or memory device is used to store the CA_PMT for each channel, so that upon a channel change requested by a user, the receiver may extract the stored CA_PMT from the cache rather than wait for the full program map table (PMT) to be transmitted by the broadcaster (see FIG. 2). In this way, the time required to display a requested digital television channel is significantly reduced.

### FIELD OF THE INVENTION

The present invention relates to an apparatus and method for digital television reception, and in particular, an apparatus and method for caching or storing conditional access information that reduces the time required to change channels in a digital television system.

### BACKGROUND OF THE INVENTION

Television transmission and reception systems in the United States and abroad are currently transitioning from analog- to digital-based content delivery mechanisms. Consumer demand for digital television services is driven by the improved resolution and overall quality of the digital content (audio and video) compared to prior analog content, as well as the additional content and services offered with digital television services.

For the broadcaster, digital television imposes requirements different from its analog predecessor. Among these requirements is the need for access security, to ensure that only paying subscribers are permitted access to subscription content, for example premium channels, pay-per-view (PPV) programs, video-on-demand (VOD) content, personal video recording (PVR) functionality, online gaming, and/or Internet access. Although access security is not a new problem, in that it was implemented in prior analog broadcasting systems, digital content delivery presents a new frontier of piracy and “bootlegging” in which the stakes are much higher for broadcasters and content developers.

Previously, video and audio content was distributed in analog format, for example using analog video tapes and analog cable television, and unauthorized copies were difficult to produce in quantity and usually substandard in quality. However, current digital techniques have eased the production of high-quality copies to the point that pirates and “bootleggers” are beginning to compete with authorized distributors in the dissemination of content. One solution to this problem is improved access security.

Digital encryption is one popular type of access security particularly suited to protect digital content. The digital content is “scrambled” during encryption in such a way that only those possessing a “decryption key” are able to descramble and receive the content. For example, a popular form of encryption known as “Data Encryption Standard” (DES) involves the exchange of a “DES key” between a content distributor and intended recipient of the content. The “DES key” is used to encrypt or scramble the digital content one or more times using a particular mathematical method, and only those in possession of the “DES key” (and having knowledge of the mathematical method) can successfully decrypt or descramble the digital content.

The mathematical method and “DES key” are specifically designed to impose a severe burden on those attempting to “guess” or discover the “DES key” without authorization from the content distributor. For example, the “DES key” may consist of a string of digital bits (i.e. “1” or “0”) in a particular order, in which the string may be 56 or more bits in length. The “DES key” string of bits may be computed using random digital bits in a public-private key exchange, e.g. a Diffie Hellman public key exchange, additional keys may then be derived by applying a secure hash algorithm (SHA), and/or a Dynamic Feedback Arrangement Scrambling Technique (DFAST) engine may be used to generate a 56-bit DES key that is not explicitly shared between distributor and subscriber. In addition, each DES key so computed may be used for only a brief period of time (e.g., 2 seconds), and then the DES key may be changed. In this way, unauthorized persons may find it difficult or impossible to determine many DES keys and descramble the content of an entire program in a reasonable amount of time.

Digital television distributors, including distributors of digital television content via, for example, terrestrial signal, cable, satellite, internet and digital subscriber line (DSL), use the moniker “conditional access” to describe their implementations of access security such as DES digital encryption. The specifics of “conditional access” usually vary from distributor to distributor, but have the common goal of preventing unauthorized access to designated program content. Recent implementations have involved broadcasting some “conditional access” information along with the digital content to be received, for example public key information in the public-private key exchange may be transmitted in addition to audio and video content.

In addition to “conditional access” information, digital television distributors usually broadcast a variety of other information that may be necessary for acquiring the program, or complements the audio and video data associated with the program. For example, program map table (PMT), program system information (PSI), program and packet identifiers (PID), electronic program guide (EPG), emergency alert system (EAS), and other command and control messages such as conditional access information may be transmitted in frequency bands inside or outside the frequency band associated with the selected television program (i.e., “in-band” or “out of band” (OOB)). The other information may correspond to data necessary to conform with various digital standards, such as, MPEG-2. This complementary information may provide to the end user information about upcoming programs, “conditional access” program information, and data for use by the receiving equipment in collecting and processing the broadcast digital content for use, e.g., display by a television set.

Due to the limited capacity or bandwidth of current digital distribution systems, the complementary information including “conditional access” program information may be transmitted or updated at a rate somewhat less than that used for television audio and video content. For example, the program map table (PMT) may be transmitted once every 400 milliseconds, while the audio and video content may be updated more frequently. More specifically, when a user/subscriber selects a “conditional access” program for display, traditional systems require current information included in the PMT in order to acquire the information required to display the “conditional access” program. Therefore, each channel change requires that the current PMT be received, i.e. each such channel change associated with conditional access programming may require at least 400 milliseconds of wait time for display. This wait time may result in an unsatisfactory experience for a user/subscriber.

Given that the satisfaction of paying subscribers may be jeopardized by the significant wait time required for “conditional access” programming, there is a need for a digital television receiver capable of reducing the amount of time required for channel changes associated with conditional access programming, designed for delivery of a variety of digital content, and may be suitable for use with conventional cable television delivery systems.

### SUMMARY OF THE INVENTION

The present invention is directed to a method and apparatus for providing faster tuning of a digital television channel, particularly, channels associated with conditional access programming. Specifically, the apparatus of the present invention is directed to a digital television receiver having a cache or memory device for storing “conditional access program map table” (CA_PMT) information. The cache or memory device is used to store the CA_PMT for each channel, so that upon a channel change requested by a user, the receiver may extract the stored CA_PMT from the cache rather than wait for the full PMT to be transmitted by the broadcaster. In this way, the time required to complete processing necessary to display a requested digital television channel is significantly reduced, resulting in increased user satisfaction.

The method of the present invention includes tuning to a first transmission channel in response to user selection of a program; retrieving conditional access mapping information associated with the first transmission channel from a memory device of the digital television receiver, the memory device storing conditional access mapping information associated with a plurality of transmission channels; receiving a descrambling key from a detachable module coupled to the digital television receiver; descrambling audio and video packets associated with the selected program in response to the descrambling key and the retrieved conditional access mapping information associated with the first transmission channel; and processing the descrambled audio and video packets to provide output signals to one or more display devices.

This combination, when employed in the configuration of the present invention, permits significantly reduced channel change time without sacrificing access security or encryption robustness or reliability. These advantages can be provided in a form suitable for use with conventional cable television delivery systems and at a reasonable cost.

### BRIEF DESCRIPTION OF THE DRAWINGS

In the drawings:

FIG. 1 is a simplified block diagram illustrating an exemplary digital television receiver circuit known in the art;

FIG. 2 is a simplified block diagram illustrating an exemplary digital television receiver circuit with conditional access cache in accordance with the present invention;

FIG. 3 is a flow diagram illustrating an exemplary method of receiving a digital television program in accordance with an alternate embodiment of the present invention; and

FIG. 4 is a pictorial block diagram illustrating an exemplary system employing a digital television receiver circuit with conditional access cache in accordance with an alternate embodiment of the present invention.

### DETAILED DESCRIPTION

The following discussion of the method and apparatus directed to a digital television receiver circuit with conditional access cache will help illuminate the features and advantages of the present invention, including its ease of formation using conventional techniques of constructing electronic devices and circuits which are well known in the art.

In the following discussion, the singular term “signal” and plural term “signals” are used interchangeably and are to be understood as including analog or digital information, at a single frequency or a plurality of frequencies, and may or may not include coding, modulation, sideband information, or other features of signals or waveforms well known in the art. Furthermore, when reference is made to a “receiver,” “transmitter,” or “input,” previous process steps may have been utilized to form signals or waveforms compatible with these features.

In addition, no particular order is required for the method steps described below, with the exception of those logically requiring the results of prior steps, for example transmitting conditional access mapping information logically requires the prior generation of the conditional access mapping information. Otherwise, enumerated steps are provided below in an exemplary order which may be altered, for instance the several reception steps may be rearranged or performed simultaneously.

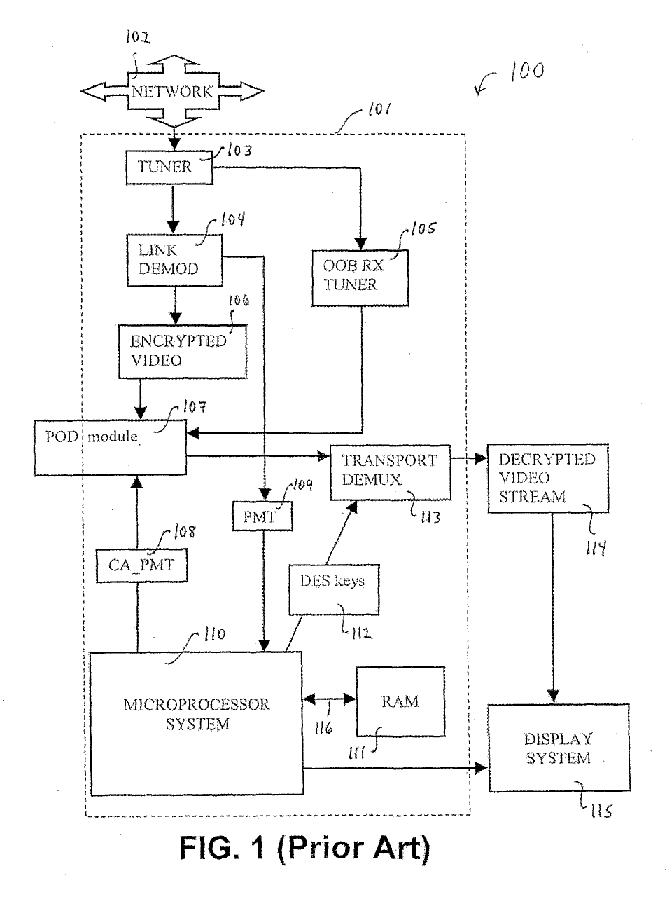

To illustrate the particular features and advantages of the invention, a digital television receiver circuit known in the art will now be described with reference to FIG. 1. FIG. 1 shows a simplified block diagram of a digital television reception and display environment generally designated 100. A digital television receiver circuit 101 is illustrated including a tuner 103 coupled to a network source 102, a link/demodulation block 104, an out of band receiver/tuner 105, a point of deployment (POD) module 107, a microprocessor system 110 including random access memory (RAM) 111, and a transport demultiplexer block 113, the output of which is coupled to a display system 115.

In operation, a broadcast carrier modulated with signals carrying audio, video, and associated data representing broadcast program content is received from network source 102 by tuner 103, which may utilize hardware and/or software components to successfully tune the in-band quadrature amplitude modulated (QAM) channel, which may use any one of a plurality of known modulation techniques. The tuner 103 produces an in-band digital output signal, which is coupled to the link/demodulation block 104, and out of band signals are coupled to the out of band receiver/tuner 105. “In band” refers to those signals transmitted using a carrier frequency traditionally associated with television transmission and reception (e.g., VHF channel 13), while “out of band” (OOB) refers to signals sent via frequencies associated with the selected television program. Information contained in the OOB signals is coupled to the POD module 107 after being tuned/received/demodulated in the OOB receiver/tuner 105.

The in-band digital output is demodulated in link/demodulator block 104. The demodulated output from block 104 includes encrypted digital video signals 106 (as well as other encrypted digital signals, e.g. audio) which are coupled to the POD module 107 for descrambling. The demodulated output from block 104 further includes auxiliary information necessary for tuning and for generating an electronic program guide, including, but not limited to, program system information (PSI), program association table (PAT), and program map table (PMT) information 109, which are coupled to the microprocessor 110.

The microprocessor system 110, including software and hardware such as RAM 111, builds a conditional access program map table (CA_PMT) 108 using the PMT information 109, including extracting conditional access descriptors and other information in accordance with, for example, EIA-679B Part B, section 8.4.3.4. The CA_PMT 108 is then transmitted to the POD module 107, which acquires the required information for descrambling the encrypted video signals 106 (as well as other signals, e.g. audio). Following processing in the POD module 107, a transport datastream consisting of packets of digital data is coupled to the transport demultiplexer block 113, along with encryption keys (e.g., DES keys) 112, packet identifiers, and other information.

At the transport demultiplexer block 113, decoding of the transport datastream occurs including separation into audio and video signals, for example Motion Picture Expert Group version 2 (MPEG2) decoding may take place. Further decryption of the digital content may occur in the transport demultiplexer block 113, for example, video and audio descrambling using DES decryption may be used prior to coupling the decrypted video 114 (and other content, e.g. audio) to the display system 115 for final decoding and display.

Note that, in the conventional digital television reception and display environment 100 described above, the microprocessor system 110 must receive the PMT 109 and build a CA_PMT 108 to accomplish each channel change associated with conditional access programming. Because the in-band PMT 109 is usually not transmitted as often as other in-band information (e.g., digital audio and video program content), the microprocessor 110 is often delayed in completing construction of the CA_PMT 108 by the tardy arrival of current PMT information 109. It is this delay that the present invention seeks to reduce or avoid, in order to decrease the amount of time required to accomplish a typical channel change.

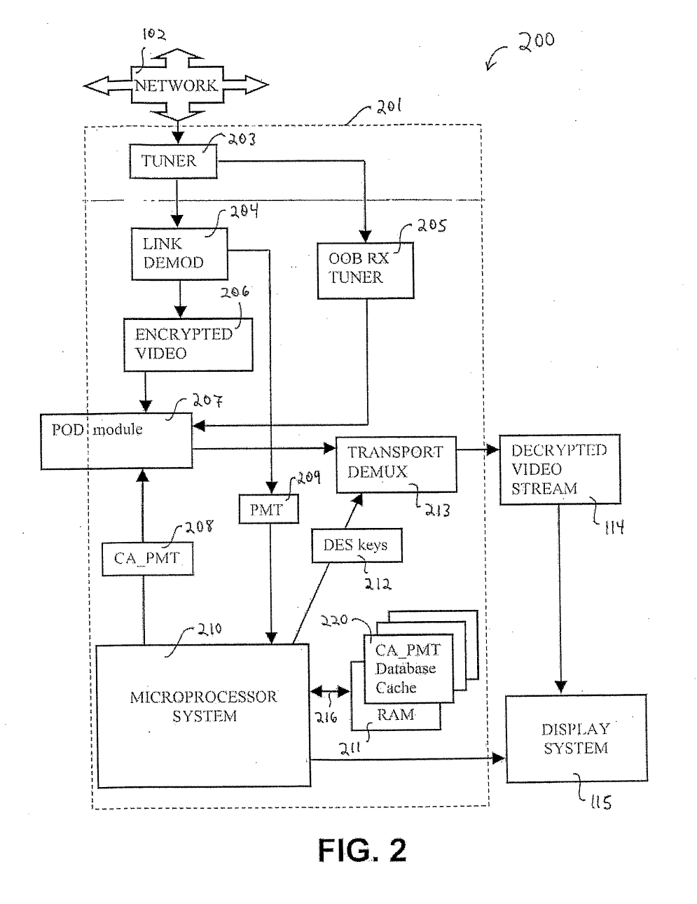

An exemplary embodiment of the invention will now be described with reference to FIG. 2. Although the invention will be described using the environment of reception of digital cable television signals, it should be apparent that the invention may be used in other types of radio-frequency communications systems as well, including reception of digital television channels via satellite, DSL, Internet, and terrestrial television transmission systems. In contrast to the prior art scheme described above, exemplary embodiments of the present invention provide reduced channel change delays using a digital television receiver circuit with conditional access information cache, thereby substantially avoiding delays associated with receiving the in-band PMT at every channel change associated with conditional access programming.

FIG. 2 shows a simplified block diagram of a digital television reception and display environment generally designated 200 in accordance with an aspect of the present invention. A digital television receiver circuit 201 is illustrated including a tuner 203 coupled to a network source 102, a link/demodulation block 204, an out of band receiver/tuner 205, a point of deployment (POD) module 207, a microprocessor system 210 including random access memory (RAM) 211 and CA_PMT database cache 220, and a transport demultiplexer block 213, the output of which is coupled to a display system 115.

In operation, a broadcast carrier modulated with signals carrying audio, video, and associated data representing broadcast program content is received from network source 102 by tuner 203, which may utilize hardware and/or software components to successfully tune the in-band quadrature amplitude modulated (QAM) channel. The tuner 203 produces an in-band digital output signal, which is coupled to the link/demodulation block 204, and out of band signals are coupled to the out of band receiver/tuner 205. Similar to terminology used to describe the known system illustrated in FIG. 1, “in band” refers to those signals transmitted using a carrier frequency traditionally associated with television transmission and reception (e.g., VHF channel 13), while “out of band” (OOB) refers to signals sent via frequencies not associated with the selected television program. Information contained in the OOB signals is coupled to the POD module 207 after being tuned/received/demodulated in the GOB receiver/tuner 205.

The in-band digital output is demodulated in link/demodulator block 204. The demodulated output from block 204 includes encrypted digital video signals 206 (as well as other encrypted digital signals, e.g. audio) which are coupled to the POD module 207 for descrambling. The demodulated output from block 204 further includes program system information (PSI), program association table (PAT), and program map table (PMT) information 209, which are coupled to the microprocessor 210.

Unlike the conventional system described with reference to FIG. 1, the microprocessor system 210 employed in the present invention includes a cache 220 for storing the CA_PMT 208 for each channel, for example in the form of a database of CA_PMT information. The microprocessor system 210, including software and hardware such as RAM 211, thus is not usually required to build a new CA_PMT 208 for each channel change, and instead merely retrieves from the CA_PMT cache 220 the applicable CA_PMT information 208 for the requested channel. If, however, the packet or program identifiers (PIDs) or other information contained in the CA_PMT 208 corresponding to the requested channel have changed since the last update of the CA_PMT database contained in the cache 220, then a current in-band PMT 209 must be obtained and used to construct a new CA_PMT 208. This new CA_PMT 208 is then used to update the information contained in the CA_PMT database cache 220. In this way, many channel change requests can be fulfilled without incurring the delay associated with receiving a new in-band PMT 209, and instead the CA_PMT 208 corresponding to the requested channel may be retrieved from the cache 220 in a substantially smaller amount of time.

It should be appreciated that cache 220 may include one or more discrete memory devices, or cache 220 may comprise a set of logical addresses (e.g., in RAM). Alternatively, cache 220 may include one or more special purpose memory devices, for example EEPROM, flash memory, or other volatile or non-volatile memory technology devices known in the art.

The CA_PMT 208 is then transmitted to the POD module 207, which acquires the information necessary for descrambling the encrypted video signals 206 (as well as other signals, e.g. audio). Following processing in the POD module 207, a transport datastream consisting of packets of digital data is coupled to the transport demultiplexer block 213, along with encryption keys (e.g., DES keys) 212, packet identifiers, and other information.

Like the conventional environment described above with reference to FIG. 1, at the transport demultiplexer block 213 decoding of the transport datastream occurs including separation into audio and video signals, for example Motion Picture Expert Group version 2 (MPEG2) decoding may take place. Further decryption of the digital content may occur in the transport demultiplexer block 213, for example, video and audio descrambling using DES decryption may be used prior to coupling the decrypted video 114 (and other content, e.g. audio) to the display system 115 for final decoding and display.

It should be appreciated that the digital tuner 203 in accordance with the present invention is not so limited to the above described operations, but the digital tuner 203 may also perform a variety of other processing operations prior to providing in-band digital output signals suitable for use in the link/demodulation block 204. For example, the digital tuner 203 may perform coding, decoding, scrambling, descrambling, rotating, and/or derotating operations prior to passing the digital output signals to link/demodulation block 204.

One or more of the digital tuner 203, link/demodulation block 204, and the OO0 receiver/tuner block 205 may include one or more demodulators and forward error-correction (FEC) circuitry, for example one or more Reed-Soloman decoders. Each of these demodulators and circuitry may be configured to perform a particular function or set of functions corresponding to the type of digital content expected to be found within the corresponding digital channel signal. For example, a first demodulator may be configured to perform quadrature amplitude modulation (QAM) demodulation of digital cable television signals; a second demodulator may be configured to perform quadrature phase shift keying (QPSK) demodulation of digital audio signals; and a third demodulator may be configured to perform vestigial sideband (VSB) demodulation of high-definition television (HDTV) signals. A person of ordinary skill in the art would readily appreciate that each of the link/demodulation block 204, the OOB receiver/tuner 205, and/or the digital tuner 203 may include circuitry for providing additional functions, for example adaptive filters for removing multi-path propagation effects, co-channel interference, and other types of radio frequency interference (RFI) well known in the art.

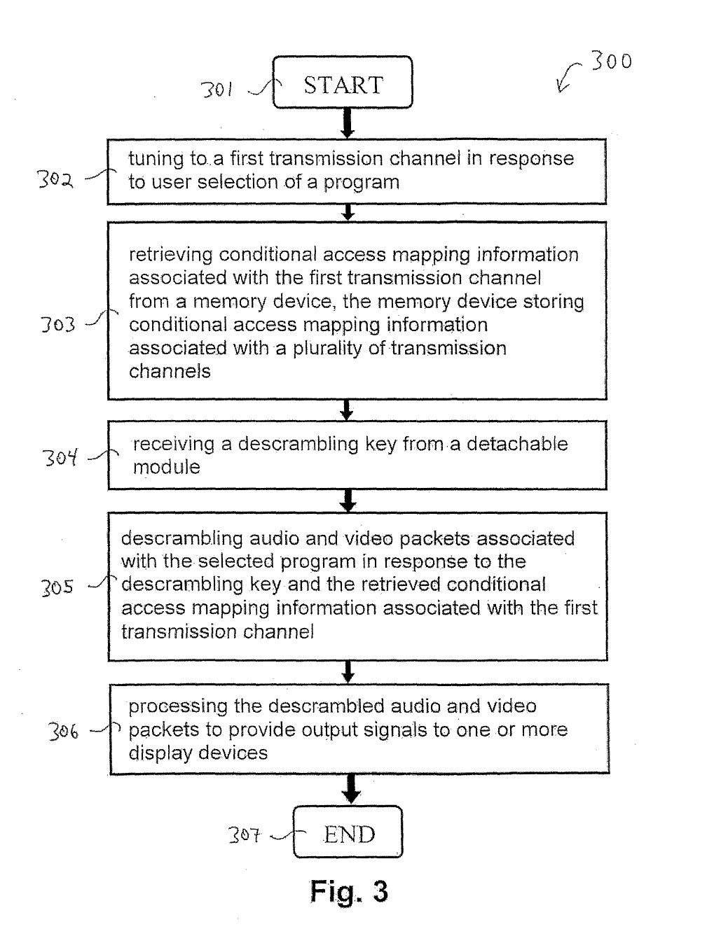

FIG. 3 shows a flow diagram representation of a method of receiving a digital television program generally designated 300 in accordance with an aspect of the present invention. The method 300 includes a tuning step 302, a retrieving step a receiving step 304, a descrambling step 305, and a processing step 306.

The method 300 begins at step 301 and proceeds to step 302 in which a user selects a digital television program and instructs a digital television receiver to tune to the transmission channel associated with the requested program.

In step 303, conditional access mapping information associated with the requested transmission channel is retrieved from a memory device which stores conditional access mapping information for a plurality of transmission channels received by the digital television receiver. For example, the memory device may include a CA_PMT database cache which holds CA_PMT information for each channel available to the digital television receiver from the cable headend. In step a descrambling key may be received from a detachable module coupled to the digital television receiver. For example, the detachable module may include a POD module in the form of a “SmartCard” or “Personal Computer Memory Card International Association” (PCMCIA) card containing circuitry designed to compute a descrambling key such as a DES key, as described above.

In step 305, audio and video packets associated with the selected program are descrambled using the descrambling key as well as the retrieved conditional access mapping information corresponding to the requested transmission channel. This descrambling step may occur in one or more sub-steps, for example the conditional access mapping information may be transmitted to the detachable module where one or more initial descrambling functions may occur, and the resulting audio and video packets along with the descrambling key may be transmitted to a transport demultiplexer (e.g., transport demultiplexer block 213 described with reference to FIG. 2 above) where additional descrambling functions may be accomplished.

In step 306, the descrambled audio and video packets are processed to provide output signals to drive one or more display devices, e.g., a video screen and speakers. For example, video, audio, and associated content may be encoded in the MPEG2 format at the broadcaster headend, and the processing of step 306 may include MPEG2 transport decoding for display/exhibition using a conventional television set and speakers. Steps 305 and 306 may be accomplished using microprocessor system 210 and transport demultiplexer block 213 described above with reference to FIG. 2. However, the present invention is not so limited and steps 305 and 306 may alternatively be accomplished in any of several other ways known in the art, for example descrambling and processing steps 305 and 306 may be performed within one or more digital processors embedded in “digital cable ready’ display devices or digital recording devices known in the art.

The method then proceeds to step 307, where it ends until a user selects another digital television channel associated with conditional access programming.

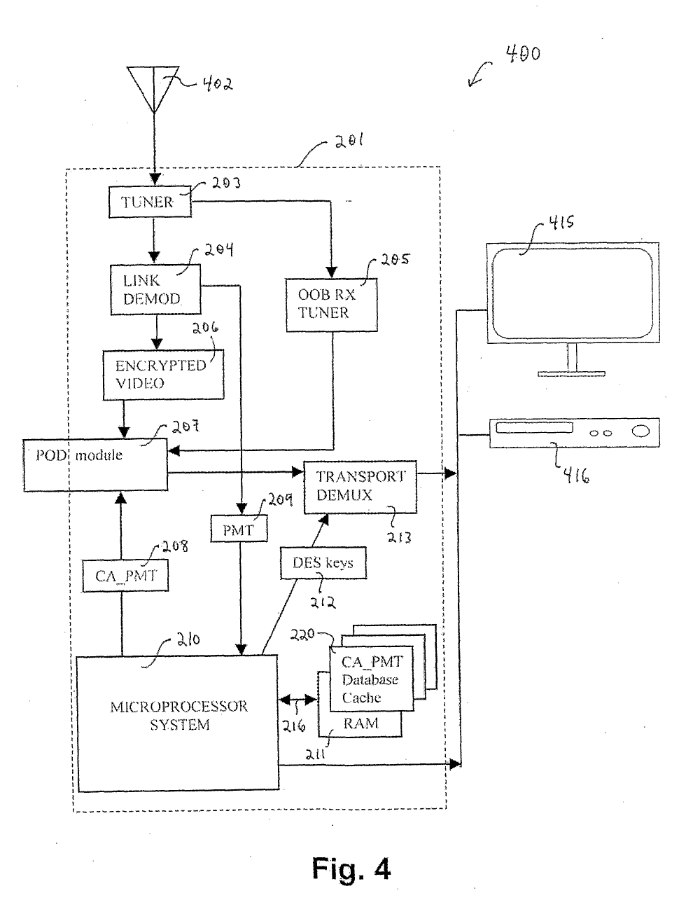

A digital television reception system utilizing caching of conditional access mapping information in accordance with an aspect of the present invention is illustrated in FIG. 4. The digital television reception system 400 includes a source signal reception device 402, a digital television receiver circuit 201, a program display device 415, and a program recording device 416. The source signal reception device 402 may include, for example, a conventional antenna configured to receive terrestrial or over-the-air (OTA) television signals. Of course, it should be apparent that source signal reception device 402 is not so limited, and may include one or a plurality of reception devices configured for placement at ground level or otherwise and configured to receive analog or digital terrestrial television signals, satellite television signals, cable television signals, or other television signals desired to be received. The source signal reception device 402 may include amplifiers, pre-amplifiers, or other components for television reception as is well known in the art. The source signal reception device 402 may be coupled to the digital television receiver circuit 201 via coaxial cable, fiber optic cable, ribbon cable, high speed data transmission line, or other signal transmission conduit known in the art.

The digital television receiver circuit 201 includes a tuner 203, a link/demodulation block 204, an out of band receiver/tuner 205, a point of deployment (POD) module 207, a microprocessor system 210 including random access memory (RAM) 211 and CA_PMT database cache 220, and a transport demultiplexer block 213, configured as described above with reference to FIG. 2 and operating in accordance with the present invention. The output signals from the receiver circuit 201 are coupled to program display device 415 and program recording device 416, respectively. Program display device 415 and program recording device 416 may include, for example, a wide-screen television display, audio processor/receiver and speakers, personal video recorder (PVR), interactive television device configured to permit Internet browsing, personal computer, or other devices with which descrambled and/or decoded digital television content may be used.

As illustrated in the preceding discussion and accompanying figures, the method and apparatus of the present invention represent an improvement in the state of the art for digital television receivers and associated methods. The present invention provides a digital television receiver circuit and method that reduces or avoids delays associated with receiving the in-band program map table (PMT) and building the conditional access program map table (CA_PMT) during every channel change associated with conditional access programming. These advantages can be embodied in a digital television receiver circuit capable of receiving a wide variety of digital content, may be produced for a reasonable cost, and may be configured for use with conventional digital television delivery systems, e.g. cable, satellite, terrestrial, internet, etc.

While the invention has been described in detail in connection with the preferred embodiments known at the time, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A method of receiving a program transmitted in a datastream of a transmission channel, comprising:
tuning to the transmission channel in response to user selection of the program;
retrieving conditional access mapping information associated with the transmission channel from a memory device, said memory device storing conditional access mapping information associated with a plurality of transmission channels;
transmitting conditional access mapping information associated with the transmission channel to a detachable security module;
receiving a descrambling key from the detachable security module;
descrambling audio and video packets associated with the selected program in response to the descrambling key;
processing the descrambled audio and video packets to provide output signals to a display device.

2. The method according to claim 1, wherein said audio and video packets associated with the selected program are received from said detachable security module.

3. The method according to claim 1, further comprising generating conditional access mapping information in response to program mapping information received with said datastream of said transmission channel, and storing said conditional access mapping information in said memory device.

4. The method according to claim 1, wherein said memory device includes a cache memory device.

5. The method according to claim 1, wherein said detachable security module is a point of deployment (POD) module.

6. A digital television receiver, comprising:
a digital tuner configured to tune to a transmission channel in response to program selection by a user;
a demodulator coupled to said digital tuner;
a memory device having stored therein a conditional access mapping information database associated with a plurality of transmission channels;
a microprocessor system coupled to said memory device and configured to retrieve a first conditional access mapping information table associated with said program selection from said stored conditional access mapping information database;
an interface for receiving a detachable security module, the interface coupled to said at least one demodulator and said microprocessor system for transmitting to said detachable security module said first conditional access mapping information table and receive a descrambling key from the detachable security module; and
a descrambler coupled to said detachable security module, said descrambler configured to descramble audio and video packets in response to said descrambling key.

7. The digital television receiver according to claim 6, wherein said microprocessor system is coupled to receive a program map table from said demodulator and configured to generate said conditional access program mapping information database in response to said program map table in response to said program selection.

8. The digital television receiver according to claim 6, wherein said database stored in said memory device includes conditional access mapping information associated with substantially all transmission channels received by said digital television receiver.

9. The digital television receiver according to claim 6, further comprising an out of band receiver configured to tune out of band digital signals and transmit an output to said detachable security module.

10. The digital television receiver according to claim 6, wherein said detachable security module comprises a point of deployment (POD) module.

11. The digital television receiver according to claim 6, wherein said descrambler includes at least a transport demultiplexer block configured to receive audio and video packets from said detachable security module and generate a stream of descrambled digital audio and video data.

12. The digital television receiver according to claim 6, wherein said microprocessor system includes at least one random access memory module.

13. The digital television receiver according to claim 6, wherein said memory device includes one or more cache memory devices configured to store said conditional access mapping information database.
